(19) United States
(12) Patent Application Publication
(10) Pub. No.: US 2016/0219141 A1
(43) Pub. Date: Jul. 28, 2016

(54) Method and System for Generic and Secure Troubleshooting of Appliances Using Wireless and Mobile Network

(71) Applicant: Brocade Communications Systems, Inc., San Jose, CA (US)

(72) Inventor: Nishi Kant, Fremont, CA (US)

(21) Appl. No.: 14/997,566

(22) Filed: Jan. 17, 2016

Related U.S. Application Data
(60) Provisional application No. 62/106,652, filed on Jan. 22, 2015.

(51) Int. Cl. H04M 1/725; H04L 29/08; H04W 24/04; H04L 12/28

(52) U.S. Cl. CPC H04M 1/72533; H04L 12/2825; H04L 67/125; H04W 24/04; H04M 1/72572; H04L 2012/2841; H04L 2012/285

(57) ABSTRACT

An appliance which includes a Bluetooth® module which is used to communicate with an appliance app on a smartphone. The appliance app connects with the appliance and with the appliance manufacturer to provide a connection path from the appliance to the manufacturer's diagnosis computer system. The appliance and the manufacturer's diagnosis computer system can then interact and perform information transfers and diagnostic operations as desired. In some cases the appliance app is also involved and is used to request user operations, both for information and to assist in the diagnosis if needed.

### RELATED APPLICATIONS

This application is a non-provisional application of Ser. No. 62/106,652, titled “Method and System for Generic and Secure Troubleshooting of Appliances Using Wireless and Mobile Network,” filed Jan. 22, 2015, which is incorporated herein by reference.

### BACKGROUND OF THE INVENTION

1. Field of the Invention

The invention relates to network connections between devices and remote servers.

2. Description of the Related Art

Most of the major home appliances and industrial appliances are yet to benefit from the various wireless connectivity solutions that are available. The refrigerator connected to the Internet has been an iconic reference for more than a decade, though often in a negative manner. Nevertheless, there are many practical problems that can be solved by using ubiquitous wireless connectivity in an innovative manner. For example, appliance companies spend a lot of money in customer support/service, where users are either trying to use the features of the device or trying to troubleshoot a problem.

Adding Wi-Fi capability into an appliance requires some access to an interaction screen or user interface, given the configuration requirements of WiFi. Adding a screen or sufficient display for user interaction with an appliance makes it more expensive and forces potential compromises in appliance design. Secondly, many appliance users may find it hard to create a WiFi association for an appliance. After this connectivity is performed, there are security issues that need to be addressed. For normal web-like security, the appliance would need mini browser like capability to create SSL connections to the desired site, for example. Finally, firewall capabilities would be needed to prevent unauthorized access into the appliance. Further, the approach is not readily extendable as it would produce WiFi proliferation, with resulting WiFi congestion problems and reduction in limited Internet Protocol (IP) addresses.

One approach taken by one manufacturer adds use of a user's telephone or cell phone in performing diagnosis. The user must be near the appliance of interest and then call the normal customer service center. When the customer service agent determines that appliance diagnosis is needed, the user is instructed to place the phone in a specific location on the appliance, turn on the appliance and then select a certain button for a certain amount of time. This will start a sequence where the appliance communicates with the manufacturer's computer system using audio tones. While this method does have many advantages and does allow direct appliance processor to manufacturer computer communication for troubleshooting, it still has many problems, at least including the need for the customer service center and agents, the user interacting with the agent and phone location and sensitivity issues. Further, the approach may not be suitable for many appliances.

There are many competing protocols and methods being developed for the Internet of Things (IoT), but each has negatives. Many rely on variations of WiFi, leading to the problems mentioned above. Other methods use different protocols, such as ZigBee®, Z-Wave® and others that are being developed or proposed. In addition to adding the hardware and firmware needed for the particular protocol to the appliance, a bridge device must be present in the vicinity to allow access to more normal Internet or wireless communications. Therefore, the various IoT communication methods all have negatives.

From the foregoing it should become obvious that creating a “connected” appliance following the normal web browser/smartphone approach or the newer IoT approach makes the overall solution quite complex and expensive.

### SUMMARY OF THE INVENTION

In embodiments according to the present invention, the appliance includes a Bluetooth® module which is used to communicate with an appliance app on a smartphone. The appliance app connects with the appliance and with the appliance manufacturer to provide a connection path from the appliance to the manufacturer's diagnosis computer system. The appliance and the manufacturer's diagnosis computer system can then interact and perform information transfers and diagnostic operations as desired. In some cases the appliance app is also involved and is used to request user operations, both for information and to assist in the diagnosis if needed.

The use of Bluetooth by the appliance resolves the various WiFi and IoT problems discussed above, yet is readily usable as the great majority of smartphones include Bluetooth. Further, as the appliances do not need communications most of the time, unlike IoT devices which rely on some form of communications at any time, the minor inconvenience of Bluetooth pairing, if security is desired, is greatly outweighed by the simplification of the overall infrastructure.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 is a block diagram illustrating connection of appliances to a smartphone to networks to the manufacturer according to the present invention.

FIG. 2 is a block diagram of a typical appliance according to the present invention.

FIG. 3 is a block diagram of a typical smartphone according to the present invention.

FIG. 4 is a flowchart of operations according to the present invention.

### DETAILED DESCRIPTION OF THE PREFERRED EMBODIMENTS

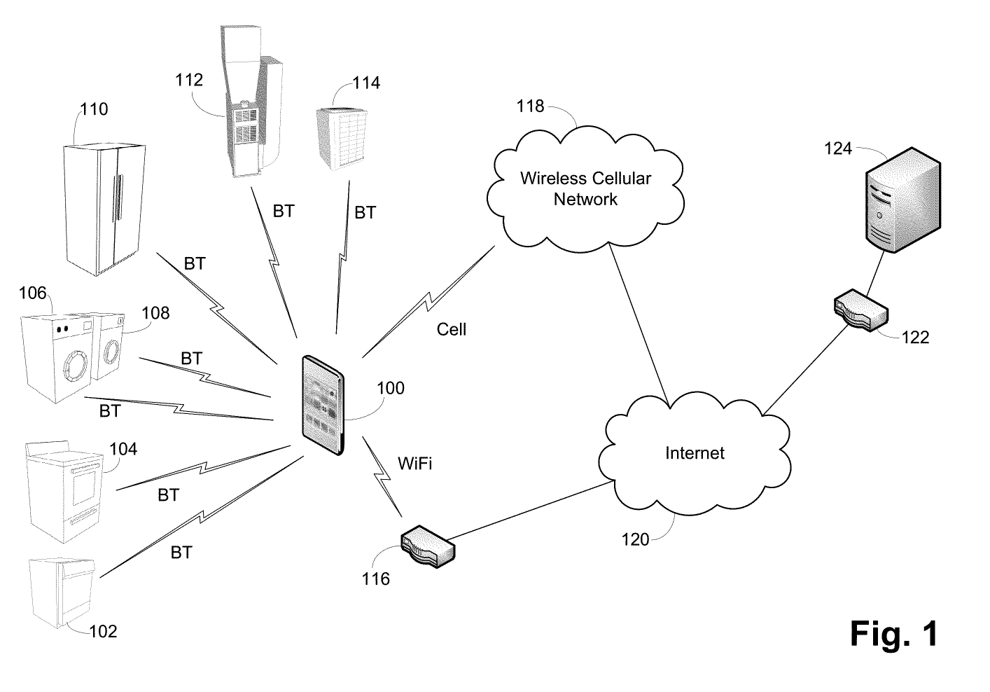

Referring to FIG. 1, a smartphone 100 is illustrated. A series of exemplary appliances, such as a dishwasher 102, a range, 104, a washing machine 106 and dryer 108, a refrigerator 100, a furnace 112 and an air conditioner 114, are illustrated as being connected to the smartphone 100 using Bluetooth wireless links. The smartphone 100 is wirelessly connected to a router 116 using WiFi and to the wireless cellular network 118, as conventional for smartphones. As normal the router 116 has a wired connection to the Internet 120. As well known, the wireless cellular network 118 is also connected to the Internet 120. A manufacturer's router/firewall 122 is connected to the Internet 120 to communication with the smartphone 100. A manufacture's diagnostic system 124 is coupled to the router/firewall 122 to allow communication with the various appliances.

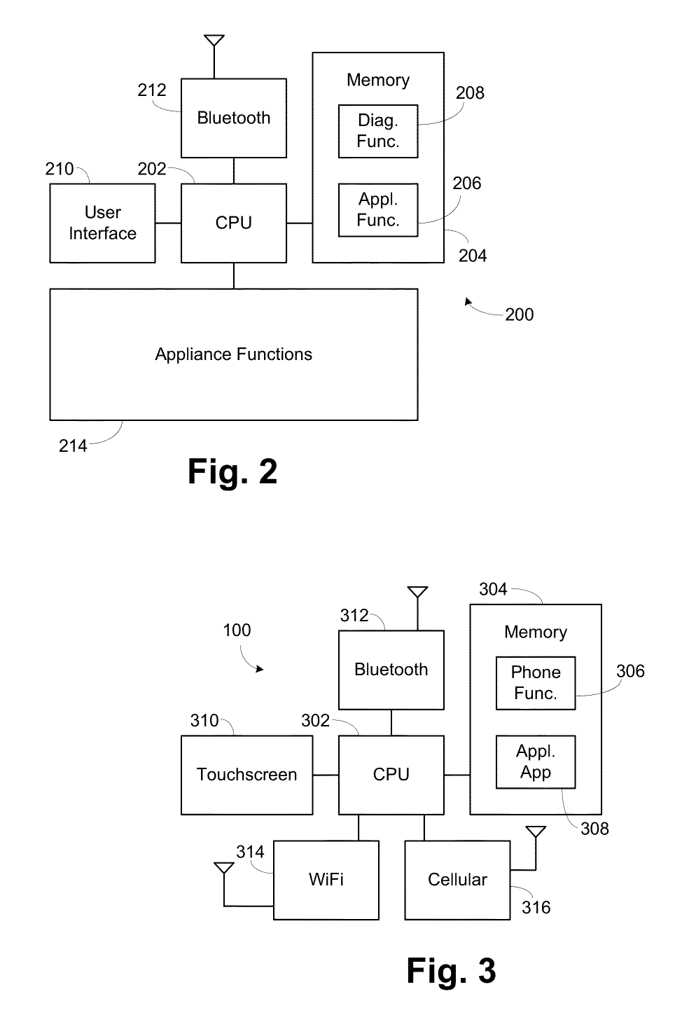

Most modern appliances contain digital components for control and monitoring of the appliance operations. They also contain self-diagnostics which usually is available to qualified technicians in form for cryptic codes. FIG. 2 is a block diagram of a typical appliance 200. A processor 202 is connected to a memory 204 which contains firmware for performing appliance functions 206 and diagnostic functions 208. The processor 202 can be any form appropriate to the appliance 200, such as a simple system on a chip (SoC) 8-bit microcomputer to a full 32-bit computer with powerful processing capabilities. A memory 204 can be included in the same chip as the processor 202, typical in an SoC, or can be a separate EEPROM and DRAM or a combination. A user interface 210 is connected to the processor 202. The user interface 210 may be any interface appropriate for the appliance 200, such as individual LEDs and limited buttons to a full touchscreen. A Bluetooth module 212 is connected to the processor 202 to provide communication according to the present invention and includes the necessary amplifiers and an antenna. The Bluetooth module 212 may also be on the same chip as the processor 202 or separate. Appliance functions 214 are illustrated connected to the processor 202 and clearly vary based on the appliance 200, but typically include motors, pumps, solenoids, relays, sensors, switches and the like.

A typical smartphone 100 is illustrated in FIG. 3. A processor or processor complex 302 is connected to a memory 304 which contains firmware/software for the normal functions and apps 306 and an appliance app 308. Again the memory 304 can be included in the same chip as the processor 302, typical in an SoC, or can be a separate EEPROM and DRAM, or a combination. A touchscreen 310 connected to the processor 302 is provided as the user interface as is typical. A Bluetooth module 312 is connected to the processor 302 to provide both conventional Bluetooth operation for the smartphone 100 and for communication with the appliance 200 and includes the necessary amplifiers and an antenna. A WiFi module 314 is connected to the processor 302 as normal to provide a first method of wireless connectivity and includes the necessary amplifiers and an antenna. A cellular interface 316 is connected to the processor 302 as normal to provide a second method of connectivity, as is common in smartphones, and includes the necessary amplifiers and an antenna.

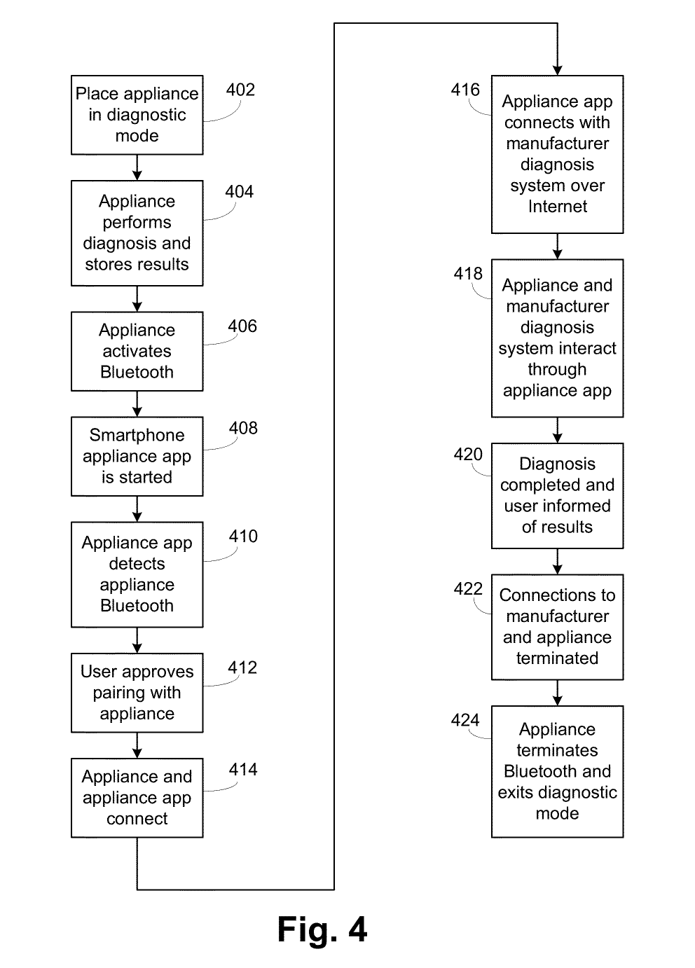

FIG. 4 is a flowchart of exemplary operations according to the present invention. In step 402 the appliance is placed in diagnostic mode. In other embodiments, the appliance or device can be placed in a communication mode. In step 404 the appliance performs diagnostic operations and stores results. Normally these results might be provided in a cryptic format but now can be provided in a more readable format. In step 406 the appliance activates the Bluetooth module, preferably in pairing mode.

In step 408 the smartphone appliance app is started. The appliance app can preferably perform many functions, such as directly displaying readable results of the diagnostics, providing troubleshooting steps, and the like.

In step 410, according to the present invention, the appliance app 410 detects the Bluetooth signal from the appliance. In step 412 the user approves a pairing request. Preferably the Bluetooth connection is according to Bluetooth Low Energy or Bluetooth Smart®, which provides several pairing options, ranging from Just Works™, which is unauthenticated, to various forms of passkey entry or approval. In the preferred embodiment a form of passkey entry is used to provide an authenticated and secure connection, but Just Works can be used if desired, with qualification of the connection done by the appliance app. Once paired, in step 414 the appliance app and the appliance make connection over the Bluetooth link.

In step 416 the appliance app connects with the manufacturer's diagnostic system over the Internet. This can be done over a WiFi connection using the house's existing network infrastructure or over a cellular connection using the mobile wireless cellular infrastructure. In step 418 the appliance and the manufacturer's diagnostic system directly communicate as needed over the established links through the Internet and the Bluetooth link. As the Bluetooth link is relatively high speed, especially as compared to audio tones, more extensive communications can occur. These communications include verifying the appliance before the appliance is instructed by the manufacturer's diagnostic system to execute diagnostic operations. The communications can also interact with the appliance app to request that the user perform selected operations and display collected data. As the Bluetooth link is wireless and can extend for some distance, specific placement as done in the audio transfer is not required.

In step 420 diagnosis is completed and the user is informed of the results using the appliance app. If parts need to be ordered and delivered, that can be done using the appliance app if desired. In step 422 the connections to both the manufacturer and the appliance are terminated by the appliance app. In step 424 the appliance shuts down the Bluetooth module and exits diagnostic mode.

The user can be an individual owner or can be a service technician present at the appliance. Instead of a smartphone, a tablet, laptop computer or other portable computer can be used, the smartphone and tablet being handheld portable computers. Further, a dedicated diagnostic computer may also be used.

Various appliances have been used as examples in this description but they are just exemplary as many other appliances can also operate according to the present invention, in residential, commercial and industrial settings. In addition, the exemplary appliances are all residential appliances, but the present invention can be used in commercial and industrial settings as well and is very suitable for appliances and machines that do not need more ubiquitous communications, just the occasional communication when the user is present at the appliance or machine.

While the description has focused on use in diagnosis, systems according to the present invention can be used for other purposes, such as firmware updates, use statistics uploading and the like, for appliances and machines that do not need more ubiquitous communications, just the occasional communication when the user is present at the appliance or machine.

From the foregoing it should become obvious that creating a “connected” appliance following the normal web browser approach makes the overall solution quite complex and expensive. Using the Bluetooth capabilities present in the great majority of smartphones dramatically simplifies the necessary infrastructure by the use of existing mechanisms with the addition of a simple Bluetooth module to the appliance or device. Users are very familiar with Bluetooth operations, so user training and frustration is minimized. With the communications provided by the Bluetooth connection and the Internet connection provided by the smartphone, complex diagnostics can be performed. The use of an appliance app allows interaction with user during and after the process and provides more usable, less cryptic results.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

I claim:

1. A system comprising:
an appliance including:
a processor;
a Bluetooth module connected to said processor;
a memory connected to said processor and containing firmware for managing appliance functions and for performing diagnostics, said diagnostics including communicating with a remote diagnostics system over a Bluetooth link and performing diagnostic operations; and
a user interface coupled to said processor; and
an appliance app for execution on a portable computer, the portable computer including a processor, a Bluetooth module connected to the processor, a memory connected to the processor and storing software for performing portable computer functions and said appliance app, at least one of a WiFi interface and a cellular interface, and a user interface coupled to the processor, said appliance app, when executed, causing the portable computer to communicate with said appliance over a Bluetooth link, to communicate with the remote diagnostics system using the at least one of a WiFi interface and a cellular interface, and to relay information between said appliance and the remote diagnostics system.

2. The system of claim 1, wherein said appliance app further causes the portable computer to display output on and receive input from the user interface to allow the user to assist in diagnostic operations when said appliance and the remote diagnostics system are communicating.

3. The system of claim 1, wherein said firmware for performing diagnostics and said appliance app cooperate to pair said appliance with the portable computer.

4. The system of claim 1, wherein said appliance app further causes the portable computer to display output on the user interface to provide the user with the results of diagnosis.

5. The system of claim 1, wherein said appliance app further causes the portable computer to display output on and receive input from the user interface to allow the user to order necessary appliance parts.

6. The system of claim 1, wherein said appliance only needs to communicate when a user is present.

7. A method comprising:
placing an appliance in a diagnostic mode, the appliance including a processor; a Bluetooth module connected to the processor; a memory connected to the processor and containing firmware for managing appliance functions and for performing diagnostics, the diagnostics including communicating with a remote diagnostics system over a Bluetooth link and performing diagnostic operations; and a user interface coupled to the processor;
activating, by the appliance, the appliance Bluetooth module;
connecting the appliance and a portable computer over a Bluetooth link, the portable computer including a processor, a Bluetooth module connected to the processor, a memory connected to the processor and storing software for performing portable computer functions and an appliance app, at least one of a WiFi interface and a cellular interface, and a user interface coupled to the processor, the appliance app causing the portable computer to communicate with the appliance over the Bluetooth link;
connecting the portable computer with the remote diagnostics system using the at least one of a WiFi interface and a cellular interface using the appliance app;
communicating diagnostic information between the appliance and the remote diagnostics system, the portable computer relaying the diagnostic information between the appliance and the remote diagnostics system using the appliance app; and
performing, by the appliance, diagnostic operations.

8. The method of claim 7, further comprising:
displaying output on and receiving input from the portable computer user interface using the appliance app to allow the user to assist in diagnostic operations when the appliance and the remote diagnostics system are communicating.

9. The method of claim 7, further comprising:
pairing the appliance with the portable computer.

10. The method of claim 7, further comprising:
displaying output on the portable computer user interface using the appliance app to provide the user with the results of diagnosis.

11. The method of claim 7, further comprising:
displaying output on and receiving input from the portable computer user interface using the appliance app to allow the user to order necessary appliance parts.

12. The method of claim 7, wherein the appliance only needs to communicate when a user is present.
